(19) United States
(12) Patent Application Publication
(10) Pub. No.: US 2009/0222459 A1
(43) Pub. Date: Sep. 3, 2009

(54) System for allowing multiple relationship/membership identifiers to be consolidated to a single identifying device

(76) Inventor: Joseph Steinberg, Teaneck, NJ (US)

Correspondence Address: JOSEPH STEINBERG, 557 STANDISH ROAD, TEANECK, NJ, 07666, US

(21) Appl. No.: 12/380,049

(22) Filed: Feb. 23, 2009

Related U.S. Application Data
(60) Provisional application No. 61/066,629, filed on Feb. 21, 2008.

(51) Int. Cl. G06F 17/30; H04W 4/12

(52) U.S. Cl. 707/10; 455/466; 707/E17.031

(57) ABSTRACT

The invention involves a method, system, apparatus, and computer code to consolidate one or more pieces of information onto an electronic device for later conveyance via wireless transmission, display in human readable form, and/or display in computer readable form. The invention improves convenience for people who today carry multiple credit cards, membership cards, tickets, coupons, and other items which can all be represented electronically on a single device. Information from multiple sources can be stored on—or accessible to—a single device and later conveyed individually or in groups in a fashion that both humans and other electronic systems can read such information. One instance of the invention, for example, would improve human convenience by allowing people to carry membership, identification, boarding passes, admission tickets, coupon, and other information electronically within their mobile phones rather than having to carry identification cards.

### RELATED APPLICATIONS AND PRIORITY

Priority is claimed to my earlier filed Provisional application U.S. 61/066,629.

### BACKGROUND OF THE INVENTION

Traditionally, relationship/membership/identification materials such as affinity-program membership cards, frequent traveler program membership cards, gym/club membership cards, store membership cards (e.g., CVS ExtraCare card), credit cards, admission tickets, boarding passes, etc. have been physical items. Often, preferred arrangements existed for those presenting membership cards (e.g., better pricing in a store or receiving membership points or “miles” in exchange for purchases; these points could then be accumulated and later exchanged for goods and/or services). People wishing to leverage the benefits of possessing these items had to present the physical cards at the time of usage—both when they conducted business that leveraged the benefit such as receiving a discount while shopping as well as when “spending” accumulated points and/or miles. If a person was a member of multiple stores' frequent buyer programs he would typically have to carry one card per store or per store chain. Sometimes the cards were credit card sized, sometimes ‘key fob’ sized, sometimes other sizes. In recent years there has been a mass proliferation of such cards—as stores, airlines, hotels, specialty shops, etc. benefit from issuing such cards and incenting users to use them as the cards allow the businesses to track business patterns and customer needs (e.g., what type of products do specific customers purchase so that businesses can properly market, advertise, stock shop shelves, etc.). As a result of the various incentives (discounts, points, etc.), people wanted to use the cards when conducting business—leading to a situation in which users often had numerous membership cards in their wallets—an inconvenience which the current invention attempts to help address.

Furthermore, coupons which customers presented for discounts or other special offers were physical items as well. If a user had multiple coupons that he intended to present at a store, for example, he needed to carry all of them to the store and present them at the time of purchase. As with membership cards, such a situation is an inconvenience for users.

Similarly, admission tickets to events such as sporting events, movies, concerts, or the theater, were physical items that users had to present to gain admission. If a person lost his or her ticket that could result in a denial of admission into an event for which he or she has paid. The same goes for train, plane, or bus tickets, and other situations in which users must present a physical item which proves that they have paid for admission into a venue or to utilize a resource.

As those skilled in the art will recognize, the inconvenience of the situation in the market vis-à-vis all of the above situations in which a user has to present a physical item has caused users several major inconveniences, including:

A) The necessity of carrying multiple cards or tickets—since the issuer of each ticket or card typically allows usage of the issued item only for its own purposes and requires its own item for its relationship so the card issued by other parties is insufficient (e.g., a person cannot use a CVS Extracare membership card at Stop-And-Shop and cannot use a Stop-And-Shop card at CVS, a ticket to a specific Giants game will not get you onto a Continental airlines flight and vice versa). Similarly people wishing to save money via coupons need to carry the coupons.

B) Less preferred arrangements when not carrying the item for a particular entity and transacting business with that entity. For example, a store might offer a discounted/sale price on an item only to people showing its affinity card and allowing the store to scan it at the time of the purchase of the item. A user who keeps the key fob version of a pharmacy membership card on his key ring, for example, and then travels without his keys and goes into the store may find himself paying higher prices and not receiving specials. Similarly, people who forget to carry coupons or lose coupons suffer from higher prices. People who forget admission tickets may be denied entrance into venues, or, may gain admission only after spending significant time “working out” the issue with security at the event—leading to frustration and/or missing portions of the event. The same holds true for bus, plane, and train tickets—in which case the situation may be worse—as the problem may be “straightened out” only after the bus, plane, or train has already departed.

The aforementioned issues are among those addressed as part of the invention.

### THE INVENTION

To this end, the present invention provides a system, method, apparatus, and computer code to provide one or more of the following:

A mechanism of managing multiple coupon codes, membership numbers, affinity program numbers, frequent buyer/renter membership numbers, frequent traveler numbers, ticket or pass numbers, other numbers or information, etc. and displaying them on a single device (e.g., mobile device or other computer) in either human or machine readable (e.g., bar codes, RFID, via Bluetooth, WIFI, etc.) or both. By storing the numbers on the device, or by allowing them to be accessed from a server (e.g., from a web server) from a device (e.g., by a mobile web browser), and by enabling the display (or other transmission of) of the membership information in computer-readable format the user is able to carry one device (which he may already be carrying as his phone or pocket computer) rather than multiple cards. Furthermore the data can easily be backed up and/or transferred between devices. The device may offer wireless capabilities (WIFI, WIMAX, cellular, Bluetooth, etc.) to speak with other systems as well. An important part of the invention is the unique method, system, apparatus, and computer code to display the membership information and/or coupon codes in a machine readable format—e.g., as an easily scannable barcode—so that, for example, a cashier in a store can scan a store membership code off the user's cellphone. If all of the user's membership codes were accessible from his or her smartphone and displayable as easily-scannable barcodes (or other computer readable codes) on the phone the user would not need to carry membership cards—just the phone which he or she is already carrying. The membership information would be more easily backed up than on paper—and credit card or debit card information would be more easily restored or updated than having to physically replace such a card. Similarly, if ticket information were transmitted to the device the user would not need to carry anything additional and would more easily be able to replace lost tickets. Security can be assured using standard mobile security tools—including the ability to limit access to authorized users via a password or even biometric checks when such capabilities are available on the mobile device being used, and the ability remotely wipe the data in case the phone is lost or stolen. All of this greatly increases user convenience.

Among the elements of this invention are several unique components—which may be implemented independently or together. Each one is an invention in itself:

1. A unique method, system, apparatus, and computer code to store information such as multiple membership numbers, coupon codes, ticket information, and/or other forms of data. and present them through a single interface in a human readable form or computer readable form.

2. A unique method, system, apparatus, and computer code to store a “super code” number which would represent different membership/relationship numbers for different entities. The super code would be translated by the invention to the actual numbers used by each individual entity. Two stores receiving the supercode, for example, could possibly translate the supercode into different information within their internal systems.

3. A unique method, system, apparatus, and computer code for displaying barcodes (using lines, boxes, or any other computer-readable printed codes) and other computer-readable and machine readable forms of data on a mobile device instead of displaying human-readable numbers on the device and printing barcodes on paper.

4. A unique method, system, apparatus, and computer code for combining items 1 and 3 above to create a unique of allowing a mobile device to be used a de-facto wallet of membership cards, credit cards, debit cards, gift cards, coupon holder, admission tickets, pass holder, or other business-relationship information.

5. A unique method, system, apparatus, and computer code for allowing people or machines to use the camera on a device (computer, mobile device, etc.) to take a picture of text and have it converted to text through character recognition. Historically, such a process required formal scanning and Optical Character Recognition and was performed on a computer; in the invention (a) the photo may be taken with a camera, not a scanner, and (b) may be processed on a computer, mobile device, or elsewhere with information relayed to a pertinent application. For example, a photograph of a user's membership card is taken on a smartphone which is transmitted to a server elsewhere where it is processed, and the relevant information sent back to the cellphone automatically. Alternatively, the information could be photographed on the cellphone and then automatically processed and stored on the server for retrieval after login. Or all of the processing could be on the mobile device itself. Photographing barcodes and processing in a similar fashion are also part of the invention. RF transmissions of info to the cellphone would be similarly processed as part of the invention—by receiving them via RF capabilities present on the mobile device (if any) rather than the camera. In any event, the processing may be done to garner information for the purposes of the other aspects of this invention (e.g., to load the information from a member's card into the invented system) or for any other purposes.

6. A unique method, system, apparatus, and computer code for doing the aforementioned in a way that is optimized for mobile-devices.

7. A unique method, system, apparatus, and computer code for doing the aforementioned in a way that is optimized for computers.

8. A unique method, system, apparatus, and computer code for doing the aforementioned in a way that is optimized for non-electronic devices.

A sample implementation of the invention would be an application that is installed on a mobile device such as a Blackberry, Palm Treo, Apple iPhone, Motorola Qphone or other smartphone that allows the user to enter membership numbers for gyms, clubs, supermarkets, pharmacies, specialty shops, airlines, train lines, rental car companies, and other business relationships, and/or allows the user to receive ticket information via download from providers issuing the tickets, and to allow the user at any time to run the application and select a particular relationship information to display and have it displayed in either/both human-readable numbers (e.g., Arabic numerals) as well as in standard bar code format (UPC) which can be scanned by a teller, check-in agent, cashier, etc., and/or transmitted via wireless transmission. Another implementation would be to have a web site that allows users to set up accounts in which business-relationship information can be stored and which the user can retrieve by logging into the web site from a computer or mobile device. Creating a mobile-optimized web site for this purpose is part of this invention. After logging in the user can select which business relationship information to display—and it would be displayed (in this example) as a human-readable number and a bar code which can be scanned and/or transmitted via some wireless transmission.

Many other implementations of the invention are possible; the aforementioned are only examples.

### BRIEF DESCRIPTION OF DRAWINGS

The following are examples of implementations of the invention:

FIG. 1 shows a membership number for a store as a bar code which can be scanned at the register.

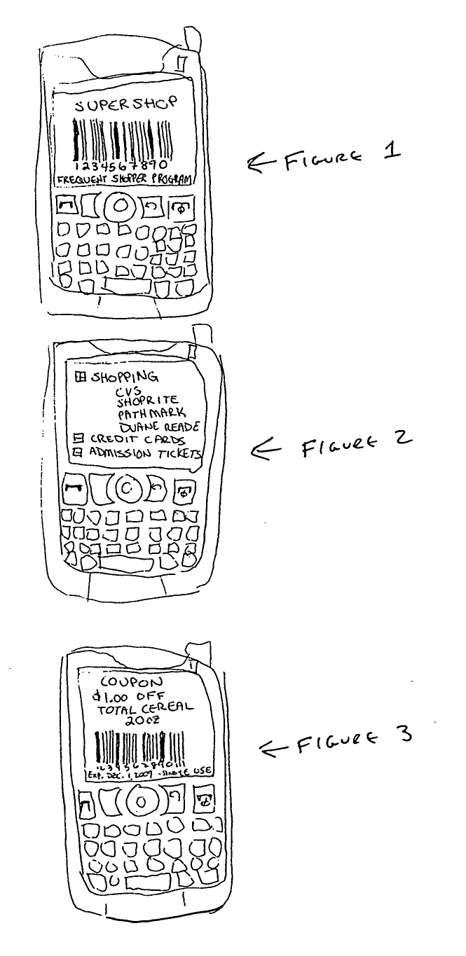

FIG. 2 shows a mobile device presenting a menu of available pieces of information which can be displayed.

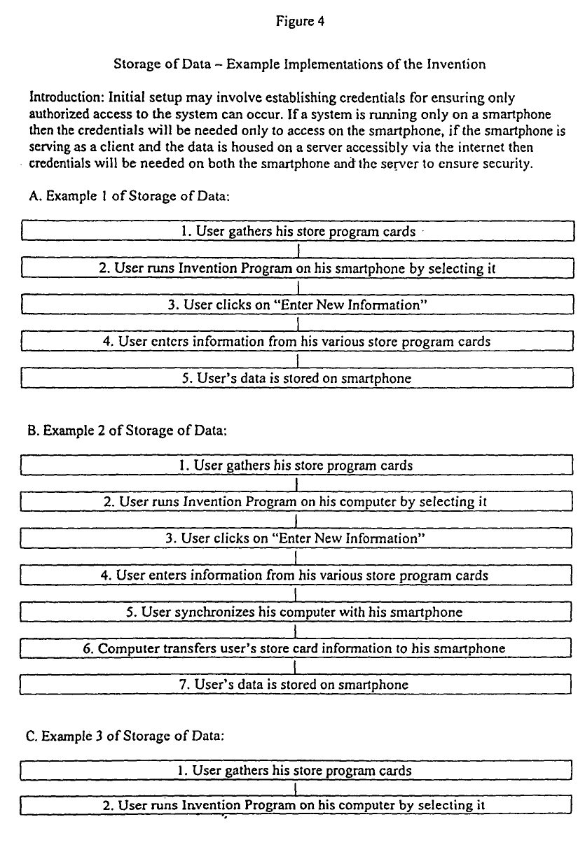

FIG. 3 shows a coupon code being displayed; the coupon having been transmitted to the user by the coupon provider.

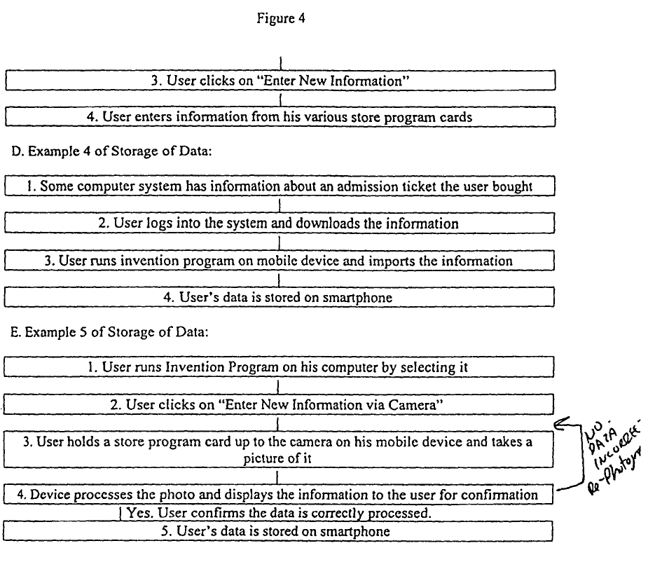

FIG. 4 shows sample flows for several example implementations of the invention.

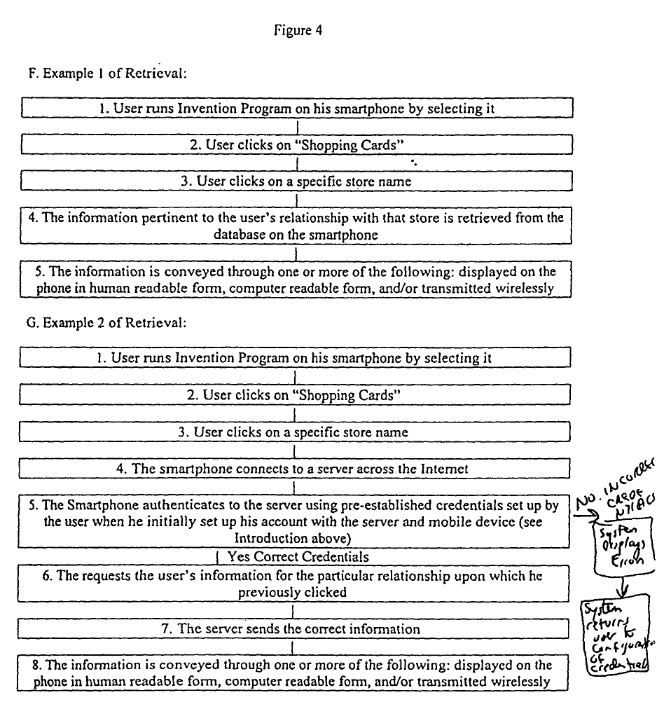

I claim:

1. A method of optimizing identification through consolidation of one or more pieces of information for use by mobile users comprising the steps of:
a. Storing at least one piece of information on, or accessible to, a mobile device.
b. Retrieving at least one piece of information through the use of the mobile device.
c. Conveying at least one piece of information from the mobile device.

2. The method of claim 1 in which the data consists of membership information, coupon information, affinity program information, frequent buyer information, frequent traveler information, frequent renter information, ticket information, pass information, club information, access information, credit card information, debit card information, and/or any other type of information that is sometimes presented in non-electronic form.

3. The method of claim 2 in which the information is conveyed by being displayed in human readable form, displayed in computer readable form, or transmitted wirelessly to another electronic device.

4. The method of claim 3 in which the data is stored on a mobile device or computer or is stored on a server and accessed from a mobile device or computer via some telecommunications connection (e.g., over the Internet via wireless connection).

5. The method of claim 3 in which a single piece of information (termed a supercode) is utilized to represent the same entity to multiple parties, even when such parties may utilize different information about said entity.

6. The method of claim 2 in which the data is entered into the device by photographing it with a camera present on the device.

7. A system for optimizing identification through consolidation of one or more pieces of information for use by mobile users comprising:
a. A module to store at least one piece of information on, or accessible to, a mobile device.
b. A module to retrieve at least one piece of information through the use of the mobile device.
c. A module to convey at least one piece of information from the mobile device.

8. The system of claim 7 further comprising data which consists of membership information, coupon information, affinity program information, frequent buyer information, frequent traveler information, frequent renter information, ticket information, pass information, club information, access information, credit card information, debit card information, and/or any other type of information that is sometimes presented in non-electronic form.

9. The system of claim 8 further comprising a module which conveys data by displaying in human readable form, displaying in computer readable form, or transmitting it wirelessly to another electronic device.

10. The system of claim 9 in which the data is stored on a mobile device or computer or is stored on a server and accessed from a mobile device or computer via some telecommunications connection (e.g., over the Internet via wireless connection).

11. The system of claim 9 in which a single piece of information (termed a supercode) is utilized to represent the same entity to multiple parties, even when such parties may utilize different information about said entity.

12. The system of claim 8 in which the data is entered into the device by photographing it with a camera present on the device.

13. A computerized-device-readable storage media that contains a program that when executed by a computerized device such as a smartphone or computer optimizes identification through consolidation of one or more pieces of information for use by mobile users by:
a. Storing at least one piece of information on, or accessible to, a mobile device.
b. Retrieving at least one piece of information through the use of the mobile device.
c. Conveying at least one piece of information from the mobile device.

14. The computerized-device-readable storage media of claim 13 that contains a program that when executed utilizes data consisting of membership information, coupon information, affinity program information, frequent buyer information, frequent traveler information, frequent renter information, ticket information, pass information, club information, access information, credit card information, debit card information, and/or any other type of information that is sometimes presented in non-electronic form.

15. The computerized-device-readable storage media of claim 14 that contains a program that when executed conveys data by displaying in human readable form, displaying in computer readable form, or transmitting it wirelessly to another electronic device.

16. The computerized-device-readable storage media of claim 15 that contains a program that when executed utilizes data stored on a mobile device or computer, or is stored on a server and accessed from a mobile device or computer via some telecommunications connection (e.g., over the Internet via wireless connection).

17. The computerized-device-readable storage media of claim 15 that contains a program that when executed utilizes a single piece of information (termed a supercode) to represent the same entity to multiple parties, even when such parties may utilize different information about said entity.

18. The computerized-device-readable storage media of claim 14 that contains a program that when executed enters information into the device by photographing it with a camera present on the device.
